(19) United States
(12) Patent Application Publication
(10) Pub. No.: US 2016/0134846 A1
(43) Pub. Date: May 12, 2016

(54) WIRELESS SECURITY CAMERA DEVICE

(71) Applicant: Halo2Cloud, Glastonbury, CT (US)

(72) Inventors: Garold C. Miller, Glastonbury, CT (US); Nathan Daniel Weinstein, Glastonbury, CT (US)

(21) Appl. No.: 14/934,597

(22) Filed: Nov. 6, 2015

Related U.S. Application Data
(60) Provisional application No. 62/076,024, filed on Nov. 6, 2014.

(51) Int. Cl. H04N 7/18; G08B 13/22

(52) U.S. Cl. CPC H04N 7/185; G08B 13/22

(57) ABSTRACT

A wireless security camera device includes a body; a base disposed at a first end of the body and adapted for insertion into and electrical connection with a light bulb socket; a rechargeable battery module housed in the body and operatively electrically connected with the base adapted for insertion into and electrical connection with a light bulb socket; power converter circuitry housed in the body and operatively electrically connected with the base and with the rechargeable battery module; a camera arranged at a second end of the body opposite the base and operatively electrically connected with the rechargeable battery module; a controller/processor housed in the body and operatively electrically connected with the camera and with the rechargeable battery module; and a wireless network package housed in the body and operatively electrically connected with the controller/processor and with the rechargeable battery module.

### CROSS REFERENCE TO RELATED APPLICATIONS

The present application is a non-provisional of and claims the benefit of U.S. Provisional Application Ser. No. 62/076,024 filed Nov. 6, 2014, which is incorporated herein by reference.

### FIELD OF INVENTION

The present invention relates generally to security camera devices, and more particularly relates to a wireless security camera device that can be installed in a standard light bulb socket.

### BACKGROUND OF THE INVENTION

Home security via internal and external security cameras is of great interest to modern-day homeowners wishing to keep track of their home, apartment, garage and office. Such a security system provides a means to keep an eye on one's property and belongings from a distance. Additionally, a camera system that can be remotely monitored allows a homeowner to look in on the house to keep track of anyone who may be in the house, even if permissibly, such as children or pets left home alone, or a babysitter or house sitter.

Many security systems require a number of cameras positioned around the house to provide full coverage of the property. Often, these cameras require hardwiring into the existing electrical systems of the house by an electrician or other professional, and once so wired, are difficult to relocate without significant electrical work. For recording and remote access, such systems need to also be wired into a computer network. A problem that is often met with such an extensive security camera system is that once the system is installed, the locations of the cameras are set and it is difficult to add additional cameras without additional wiring and installation headaches. Further, there is often little remote control over the cameras other than being able to view footage from a remotely connected device. Any adjustments to the camera, such as direction, zoom and focus, must be done manually.

In view of the foregoing, it is desirable to have a security camera device that is easily movable without having to redo the wiring for the entire system. It is also desirable to have a security camera system that is easily accessible from a remote location so that the homeowner can see what is being filmed by the camera, and what may be going on in one's house. Accordingly, what is needed is an easy do-it-yourself means of installing a security camera without hardwiring into an electrical system or a computer network. Additionally, what is needed is an ability to have remote access and remote control over the camera's operation.

### SUMMARY OF THE INVENTION

Thus, in accordance with an aspect of the invention, embodiments of the invention provide a security camera system that can wirelessly communicate with a computer network, both a local network (i.e., in-house) and a remote network (e.g., a cloud computing network), to make the security system easily accessible from both local locations, such as a house computer, and a remote location, such as via a portable computer, a smart phone, or a tablet computing device.

In accordance with another aspect of the invention, such a security camera system provides the ability to film and record video, and to access live or recorded video from any location. Additionally, such a security camera system may provide audio streaming in addition to video streaming, and even may provide a user with means to transmit audio from a remote location, such as from a portable computer, smart phone or tablet computing device connected to the camera via a computer network.

In accordance with another aspect of the invention, embodiments of the invention provide a wireless security camera device that can be controlled from a remote location—that is, has structural components for receiving wireless commands and for adjusting rotational yaw and pitch positioning of the camera in multiple axes, zooming in and out, and adjusting focus in response to such wireless commands.

For example, a home owner on vacation could access a cloud computing account and have access to a live feed from the camera, as well as recorded footage filmed by the camera, and further to have remote control of the camera's operation. Such a camera device can wirelessly transmit footage to a local hard drive and/or a remote cloud computing storage account per pre-designated instructions from the homeowner. The homeowner would also have the real-time capability of modifying such instructions—for example, from a remotely located laptop computer, smart phone, or tablet computing device.

Accordingly, it is a general object of the present invention to provide a wirelessly connectable security camera device that improves upon conventional security systems and security camera designs currently on the market and that overcomes the problems and drawbacks associated with such prior art security devices.

These and other objects, features and advantages of the present invention will become apparent in light of the detailed description of embodiments thereof, as illustrated in the accompanying drawings.

### BRIEF DESCRIPTION OF THE DRAWINGS

FIG. 1 shows a perspective view of a wireless security camera device in accordance with a first embodiment of the present invention.

FIG. 2 shows a perspective view of a wireless security camera device in accordance with a second embodiment of the present invention.

FIG. 3 shows a first network schematic of a wireless security camera device in accordance with embodiments of the invention.

FIG. 4 shows a second network schematic of a wireless security camera device in accordance with embodiments of the invention.

### DETAILED DESCRIPTION OF THE DRAWINGS

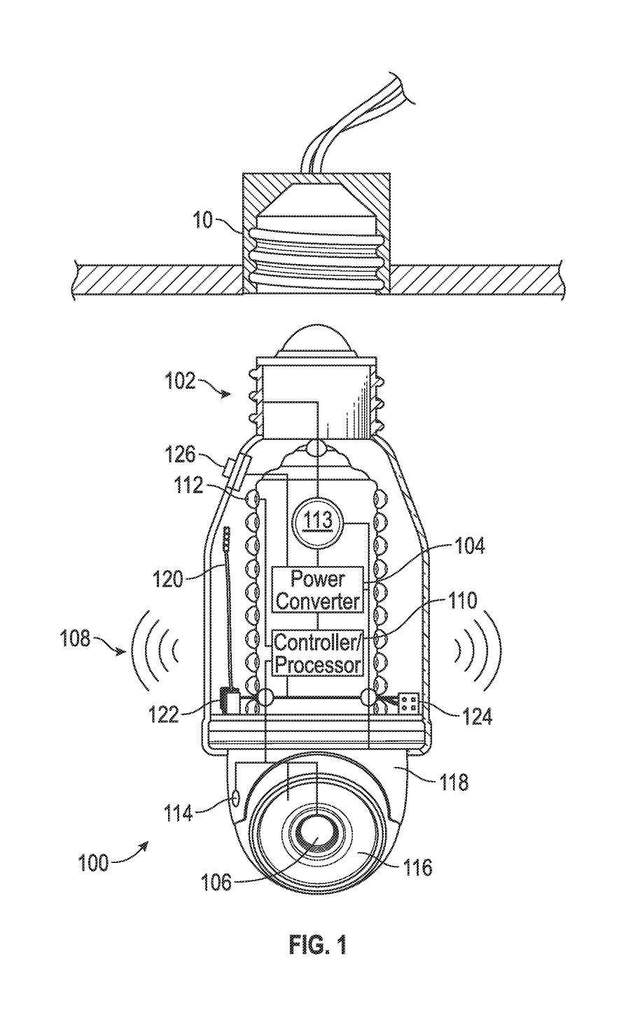

A wireless security camera device 100, in accordance with the present invention, is illustrated in FIG. 1. The camera device 100 is adapted to be installed into a standard light bulb socket 10 and includes a light bulb base 102 whereby the camera may be powered through the light socket by the room's pre-existing electrical wiring. As will be described in more detail below, the camera device 100 is also wireless connectable to a computer network, thus does not require any network wiring for operation. In this regard, the camera device 100 can be installed and used without the need of any new wiring to connect the camera to the electrical system of the room or the computer network of the room. As a result, the present invention provides an easy do-it-yourself means of installing a security camera without needing hardwiring into the electrical system or a computer network while further permitting remote access to view and/or listen to the camera feed.

As illustrated in FIG. 1, the camera device 100 can be installed using the standard light socket receptacle 10, such as a recessed lighting fixture. At a first end, the camera device 100 has the light bulb base 102 with electrical contacts that are sized and threaded to mimic a light bulb so as to easily screw into the socket. Once in place, the light bulb base 102 on the first end will operatively communicate with complementary contacts within the socket to transmit AC power to the camera for operation. Internally, the camera device 100 includes rectifier/power converter circuitry 104 for reducing the AC power to standard USB (5 V DC, 1 A or 2 A) current for operation of off-the-shelf camera components. The camera device 100 also houses a camera 106, a wireless networking package 108, a controller/processor 110, a light source 112, a rechargeable battery 113, and optionally a microphone 114, a speaker 116, and camera gimbal motors 118.

The power converter circuitry 104 is operatively electrically connected to provide power to the other components of the camera device 100.

The second end of the camera device 100 (opposite the light bulb base 102) houses the digital camera 106 and the light source 112. The digital camera 106 may be any conventional off-the-shelf camera, using CCD or equivalent low power technology. The light source 112 may include low-current lighting elements, such as a series of LED lights, for illuminating a room sufficiently for video capture. Preferably, the light source 112 is sufficiently bright to substitute for a standard light bulb, thereby concealing the location of the camera device 100 and also providing room lighting from the same light socket taken up by the camera device.

Inside the body of the camera device 100, the wireless networking package 108 includes an antenna 120, which is operatively electrically connected with a wireless transmitter 122 and with a wireless receiver 124. The wireless transmitter 122 provides for transmitting video footage from the camera 106 to a computer network, either a local hard drive, or a remote cloud computing drive, or both, in accordance with the user's instructions. The wireless receiver 124 provides for receiving signals via the network for operation and control of the camera, e.g., positioning commands for the gimbal motors 118 and/or focusing commands for the camera 106. The wireless transmitter and receiver 122, 124, as well as the controller/processor 110, utilize standard components known to one of ordinary skill in the art in connection with wireless transmission of signals. In general, the wireless transmitter/receiver 122, 124 can communicate with a wireless router or a wireless hot spot within an operating range. Once connected to a network, for example, via a home computer, signals can be transmitted for real-time viewing, or recorded and stored, as desired. Preferably, multiple devices can be connected to the system for viewing or control purposes.

The controller/processor 110 is operatively electrically connected to coordinate operation of the other components of the camera device 100, including the power converter circuitry 104. For example, the controller/processor 110 communicates video data from the camera 106 to the wireless networking package 108. The controller/processor 110 also communicates audio data between the microphone 114, the wireless networking package 108, and the speaker 116. Further, the controller/processor 110 communicates positioning commands from the wireless networking package 108 to the gimbal motors 118.

The rechargeable battery module 113 is provided in the body of the camera device 100 and is operatively electrically connected to receive standard USB power from the power converter circuitry 104 and to convert back and forth between the standard USB power and rechargeable battery power (different DC voltages and currents). The rechargeable battery module 113 may include any type of rechargeable battery, for example, a NiMH or Li-Ion 9 V battery. The rechargeable battery module 113 may provide for removal and replacement of the rechargeable battery. Additionally, the rechargeable battery module 113 provides for continued operation of the camera device 100, during times when AC power is not supplied to a light socket into which the light bulb base 102 has been screwed.

The camera may include a manual power button 126, which is operatively electrically connected with the controller/processor 110, for turning the camera 100 on and off. More preferably, the controller/processor 110 may be programmed to support a remote power signal, whereby the camera can be turned on and off remotely via the wireless networking package 108, for example from a home computer, portable computer, smart phone or tablet computing device that is wirelessly connected to the camera device 100 via a local area network or via a wide area network as discussed above.

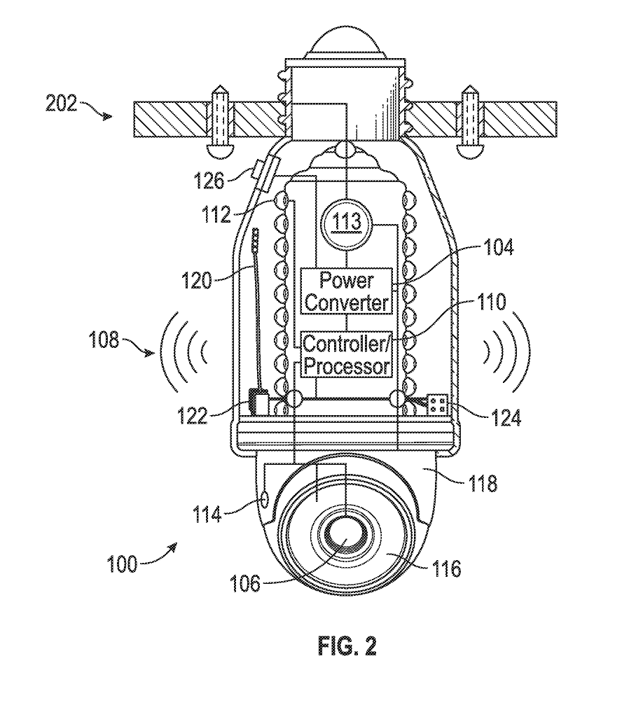

Referring to FIG. 2, components similar to those of FIG. 1 are similarly numbered and are not further described in detail. FIG. 2 illustrates as a second embodiment of the invention a security camera device 200, which has at a first end a standard mounting flange 202 for installation onto a wall or ceiling surface using standard fasteners 203. In this embodiment, the security camera device 200 is powered exclusively from the rechargeable battery 113, which accordingly is replaced from time to time. As in the security camera device 100 of FIG. 1, the power converter circuitry 204 in this embodiment is configured to provide 4 V / 1 A USB standard power based on the power available from the battery 113. The battery 230 may be, for example, a NiMH or Li-Ion 9 V battery.

As discussed, the security camera devices 100, 200 may include appropriate servo-motors and bearing means (collectively, the gimbal motors 118) for positioning and operational control of the camera 106. For example, a remotely located user who is connected to an appropriate camera account via a computer network can control the camera 106 from a remote location. Thus, the security camera device 100, 200 includes structural components for adjusting yaw and pitch positioning of the camera 106 in multiple axes (e.g., x-, y- and z-axes), for optically zooming the camera 106 in and out, and/or for adjusting camera focus. In certain embodiments, such control may be accomplished manually (via switches 334 provided on the wall mounting flange 301) as well as via remote means of control, such as using a home computer, portable computer, smart phone, or tablet computing device. Typically, operational adjustments can be accomplished remotely via the wireless network package 108 and the controller/processor 110.

As mentioned, the low-current light source may be provided in the body of the camera device 100, 200 so as to illuminate a room as needed for optimal camera operation.

Additionally, the camera device may further include the microphone 114 for recording and providing audio streaming in addition to video streaming. Even further, the camera device may include the speaker 116 that permits the user to transmit an audio signal from a remote location, such as from a portable computer, smart phone or tablet computing device connected to the camera via a computer network, such as communicating with children or pets left home alone even from a remote location, such as a restaurant.

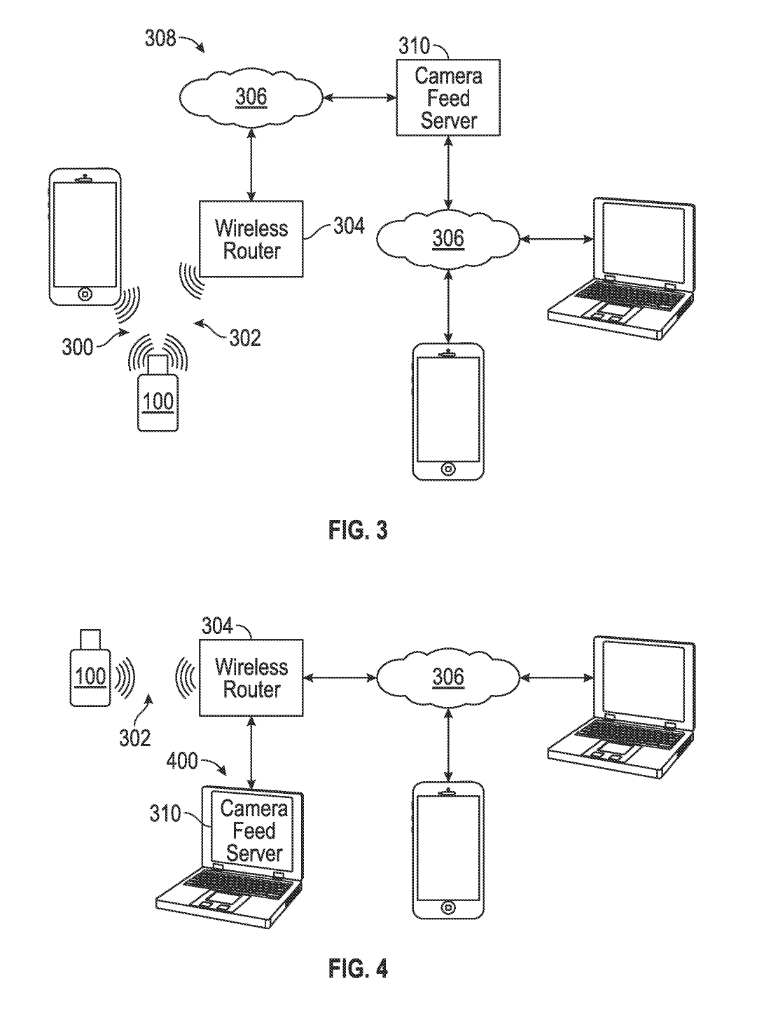

Referring to FIG. 3, in use, one simply screws the camera device 100 into a light socket, or mounts the camera device 200 onto a wall or ceiling, then activates 300 the camera device 100 from a handheld wireless device (e.g., a cellular phone utilizing Direct WiFi). Once activated, the camera device 100 or 200 then is configurable to connect 302 via a home wireless router 304 to a wide area network 306. Using the WAN 306, the camera device 100 can “phone home” 308 to a camera feed web server 310, which acts as a dynamic domain name server for two-way communication with the camera devices. On the camera feed web server 310, a web account can be set up for each device of which one wishes to access the video and audio feeds. The camera feed web server 310 provides appropriate security settings, e.g. password protection and encryption, to preserve the privacy of the feeds. Alternatively, a single account can be set up on the server 310 to accommodate multiple security camera devices, identifiable for example by uniquely-assigned serial numbers that auto-update in the dynamic domain name server. Thus, the security camera devices associated with a web account can be assigned descriptive names such as, e.g., “Living Room” or “Utility Room”.

The position and focus of each security camera device can be set prior to leaving the house, or at any time. Such adjustment can be done either locally (i.e., manually), remotely within the house (e.g., using a home computer), or even after the fact via the camera feed web server 310 when the user has left the house (e.g., using a portable computer, a smart phone, or a tablet computing device). The video and audio feeds that are captured may be viewed in real-time, by multiple individuals accessing the appropriate account, and may also be recorded and stored in encrypted format for latter viewing or reference. Such video and audio signals may be transmitted from the camera feed web server 310 to a local hard drive and a remote cloud computing drive for access and storage.

In another embodiment, as shown in FIG. 4, software may be provided with the security camera devices 100, 200 that allows a home computer 400 to be configured as the camera feed web server 310. In such case, the home computer 400 needs to be configured as an externally facing web server with a static i.p. address, or needs to be associated with a dynamic domain name server, in a manner familiar to the ordinary skilled worker in information technology. The embodiment of FIG. 3 is preferred for use by average consumers.

Advantageous, a user can access the camera feeds from a remote location, such as from vacation or a restaurant, via one of the camera feed web servers 300 or 400. From such a remote vantage point, the user can also adjust the positioning, zoom and focus of the camera 106. Further, the user may also provide an audio signal via the speaker 116 to communicate with someone or something inside the room.

Further, the camera devices 100 can easily be manually repositioned to a different location within a room or to different rooms by unscrewing the device from the light socket and screwing it into another light socket. Alternatively, the camera device 200 can easily be manually repositioned by moving the mounting flange 202. No rewiring or reprogramming is needed when one of the camera devices is moved, aside from possibly updating the name of the device in the camera feed server 300 or 400.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A wireless security camera device comprising:
a body;
a base disposed at a first end of the body and adapted for mechanical insertion into and electrical connection with a light bulb socket;
power converter circuitry housed in the body and operatively electrically connected with the base;
a camera arranged at a second end of the body opposite the base and operatively electrically connected with the power converter circuitry;
a controller/processor housed in the body and operatively electrically connected with the camera and with the power converter circuitry; and
a wireless network package housed in the body and operatively electrically connected with the controller/processor and with the power converter circuitry.

2. The device of claim 1 further comprising a rechargeable battery module housed in the body and operatively electrically connected with the power converter circuitry, the controller/processor, the camera, and the wireless network package.

3. The device of claim 1 further comprising an audio microphone housed in the body and operatively electrically connected with the controller/processor.

4. The device of claim 1 further comprising an audio speaker housed in the body and operatively electrically connected with the controller/processor and with the power converter circuitry.

5. The device of claim 1 further comprising gimbal motors housed in the body and operatively mechanically connected with the camera and operatively electrically connected with the power converter circuitry and with the controller/processor.

6. The device of claim 1 further comprising a light source housed in the body and operatively electrically connected with the power converter circuitry.

7. The device of claim 6 wherein the light source also is operatively electrically connected with the controller/processor.

8. The device of claim 1 wherein at least a portion of the body is transparent and the camera is housed within the transparent portion of the body.

9. A wireless security camera device comprising:
a body;
a base disposed at a first end of the body and adapted for mechanical insertion into and electrical connection with a light bulb socket;
a rechargeable battery module housed in the body and operatively electrically connected with the base;
a camera arranged at a second end of the body opposite the base and operatively electrically connected with the rechargeable battery module;
a controller/processor housed in the body and operatively electrically connected with the camera and with the rechargeable battery module; and
a wireless network package housed in the body and operatively electrically connected with the controller/processor and with the rechargeable battery module.

10. The device of claim 9 further comprising power converter circuitry housed in the body and operatively electrically connected with the base and with the rechargeable battery module.

11. The device of claim 9 further comprising an audio microphone housed in the body and operatively electrically connected with the controller/processor.

12. The device of claim 9 further comprising an audio speaker housed in the body and operatively electrically connected with the controller/processor and with the rechargeable battery module.

13. The device of claim 9 further comprising gimbal motors housed in the body and operatively mechanically connected with the camera and operatively electrically connected with the rechargeable battery module and with the controller/processor.

14. The device of claim 9 further comprising a light source housed in the body and operatively electrically connected with the rechargeable battery module.

15. The device of claim 14 wherein the light source also is operatively electrically connected with the controller/processor.

16. The device of claim 9 wherein at least a portion of the body is transparent and the camera is housed within the transparent portion of the body.

17. A wireless security camera device comprising:
a body;
a base disposed at a first end of the body and adapted for insertion into and electrical connection with a light bulb socket;
a rechargeable battery module housed in the body and operatively electrically connected with the base adapted for insertion into and electrical connection with a light bulb socket;
power converter circuitry housed in the body and operatively electrically connected with the base and with the rechargeable battery module;
a camera arranged at a second end of the body opposite the base and operatively electrically connected with the rechargeable battery module;
a controller/processor housed in the body and operatively electrically connected with the camera and with the rechargeable battery module; and
a wireless network package housed in the body and operatively electrically connected with the controller/processor and with the rechargeable battery module.

18. The device of claim 17 further comprising a light source housed in the body and operatively electrically connected with the rechargeable battery module.

19. The device of claim 17 wherein at least a portion of the body is transparent and the camera is housed within the transparent portion of the body.

20. The device of claim 17 further comprising gimbal motors housed in the body and operatively mechanically connected with the camera and operatively electrically connected with the rechargeable battery module and with the controller/processor.
